(19) United States
(12) Patent Application Publication
(10) Pub. No.: US 2016/0339878 A1
(43) Pub. Date: Nov. 24, 2016

(54) CAR WASH DETECTION METHOD AND APPARATUS

(71) Applicant: Honda Motor Co., Ltd., Tokyo (JP)

(72) Inventor: Thomas G. Kracker, Marysville, OH (US)

(21) Appl. No.: 14/714,490

(22) Filed: May 18, 2015

(51) Int. Cl. B60S 3/04; B60S 1/08

(52) U.S. Cl. CPC B60S 3/04; B60S 1/0862

(57) ABSTRACT

A car wash detection method includes detecting a factor caused by a washing operation of a car wash. The car wash detection method further includes automatically disabling a wiper assembly of a vehicle in response to detecting the factor. A car wash detection apparatus includes a sensor and a controller. The sensor is configured to detect a factor caused by a washing operation of a car wash. The controller is configured to automatically disable a wiper assembly of a vehicle in response to receiving a signal from the sensor indicating detection of the factor. A vehicle including a car wash detection apparatus is also provided.

### BACKGROUND

Car washes can include elements that contact a vehicle. These elements can cause damage to an operational wiper assembly. A method and apparatus of car wash detection for preventing damage to a wiper assembly is desirable.

### SUMMARY

Provided are a plurality of example embodiments, including, but not limited to, methods and apparatus of car wash detection for preventing damage to a wiper assembly. In particular, the following presents a simplified summary of the disclosure in order to provide a basic understanding of some example aspects described in the detailed description.

In one example, a car wash detection method includes detecting a factor caused by a washing operation of a car wash. The example car wash detection method further includes automatically disabling a wiper assembly of a vehicle in response to detecting the factor.

In another example, a car wash detection apparatus includes a sensor and a controller. The sensor is configured to detect a factor caused by a washing operation of a car wash. The controller is configured to automatically disable a wiper assembly of a vehicle in response to receiving a signal from the sensor indicating detection of the factor.

In yet another example, a vehicle includes a car wash detection apparatus.

Also provided are additional example embodiments, some, but not all of which, are described hereinbelow in more detail.

### BRIEF DESCRIPTION OF THE DRAWINGS

The features and advantages of the example embodiments described herein will become apparent to those skilled in the art to which this disclosure relates upon reading the following description, with reference to the accompanying drawings, in which:

FIG. 1 schematically illustrates an example vehicle including an example wiper assembly including an example car wash detection apparatus in accordance with examples of the disclosure.

FIG. 2 schematically illustrates an example car wash detection method in accordance with examples of the disclosure.

FIG. 3 schematically illustrates another example car wash detection method in accordance with examples of the disclosure.

### DETAILED DESCRIPTION OF THE EXAMPLE EMBODIMENTS

Examples will now be described more fully hereinafter with reference to the accompanying drawings in which example embodiments are shown. Whenever possible, the same reference numerals are used throughout the drawings to refer to the same or like parts. However, aspects may be embodied in many different forms and should not be construed as limited to the embodiments set forth herein.

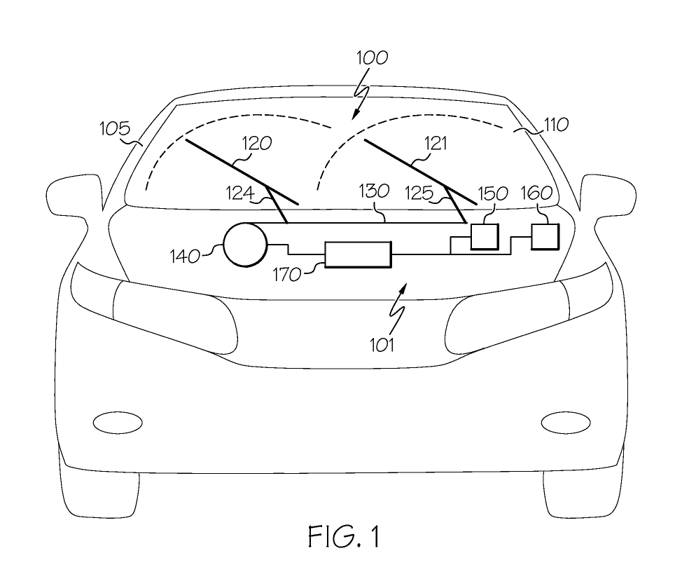

A method and apparatus of car wash detection for preventing damage to a wiper assembly are provided. As illustrated in FIG. 1, an example wiper assembly 100 of a vehicle 105 can include wiper blades 120, 121, wiper arms 124, 125, and a wiper connecting member 130. The wiper blades 120, 121 can include a rubber blade configured to wipe a surface (e.g. remove or control the flow of liquid on the surface). In one example, the surface can include a windshield 110 of the vehicle 105. The wiper assembly 100 can further include a motor 140 configured to operate the wiper blades 120, 121 to wipe the windshield 110. The motor 140 can transfer mechanical motion via the wiper connecting member 130 to the wiper arms 124, 125 which, in turn, move to operate the wiper blades 120, 121 to wipe the windshield 110. It is to be understood that the wiper assembly 100 of FIG. 1 is a schematic illustration of an example wiper assembly of a vehicle and should not be construed to limit the type or operation of wiper assembly contemplated in the disclosure. Accordingly, the disclosure applies equally to other wiper assemblies, including those not illustrated or explicitly described.

As noted above, in operation, the wiper assembly 100 can operate to wipe the windshield 110. During this operation, the wiper blades 120, 121, as well as the wiper arms 124, 125 and the wiper connecting member 130 move about. Damage to the wiper assembly 100 may occur if the prescribed motion of the wiper assembly 100 is substantially restricted or if one or more of the components of the wiper assembly 100 is contacted by elements external to the wiper assembly 100. For example, if an element of a car wash (not shown) contacts the operating wiper assembly, excessive wear or damage to the wiper assembly 100 may occur.

In one example the car wash includes a roller type car wash having brushes in the form of rollers that are configured to contact the exterior of the vehicle to scrub, polish, or otherwise clean the vehicle. In another example, the car wash includes a curtain type car wash having scrubbing strands configured to contact the exterior of the vehicle to scrub, polish, or otherwise clean the vehicle. In still another example, the car wash includes nozzles configured to spray water on the vehicle and/or blowers configured to blow air on the vehicle. For purposes of this disclosure, it is to be understood that an “element” of the car wash includes any component, brush, scrubber, soap, liquid, air, or other element of the car wash that contacts the vehicle during a washing operation of the car wash. For purposes of this disclosure, it is to be understood that a “washing operation of a car wash” includes any operation of the car wash configured to clean, scrub, rinse, dry, or otherwise wash the vehicle.

In one example, a scrubbing strand or a brush of the car wash may become entangled with one or more of the wiper blades 120, 121 as the wiper blades wipe the windshield 110. Such an entanglement can disconnect or break the wiper assembly 100 by, for example, cracking or snapping the one or more wiper blades 120, 121, the wiper arms 124, 125, or the wiper connecting member 130. In another example, such an entanglement can restrict or counteract the prescribed motion of the wiper assembly 100 and thus damage or cause excessive wear to the motor 140 by, for example, stripping a gear of the motor 140, overheating the motor 140, and/or causing the motor 140 to burn out. In still other examples, damage to the wiper assembly 100 can include any unwanted interaction and damage therefrom between any component of the wiper assembly 100 and any element of the car wash contacting the vehicle. Accordingly, the disclosure applies equally to any car wash having one or a combination of elements configured to contact the exterior of the vehicle, and should not be limited to the specific example car washes disclosed herein.

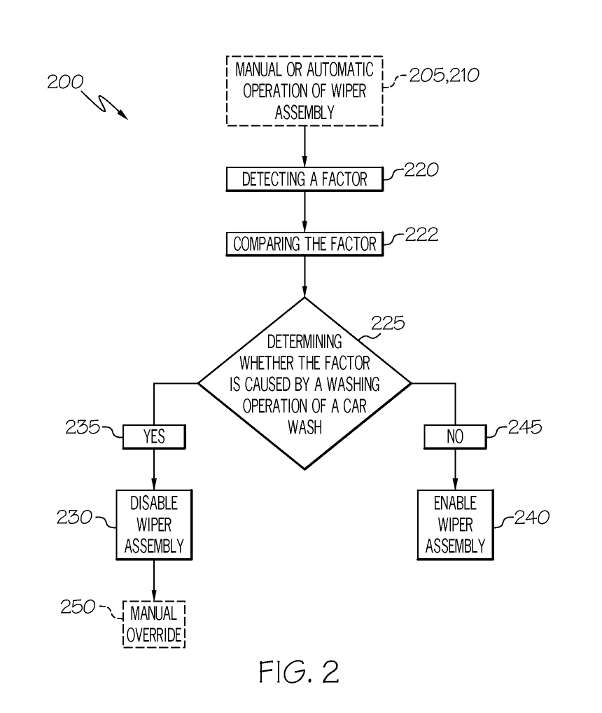

To prevent damage to the wiper assembly 100, a car wash detection method may be implemented. As illustrated in FIG. 2 and as discussed more fully below, the car wash detection method 200 can include detecting a factor caused by a washing operation of a car wash 220, comparing the factor 222, and determining whether the factor is caused by a washing operation of a car wash 225. It is to be understood that the example car wash method 200 can be performed a single time, more than one time, or continuously in a loop, for example. Still further, the method 200 includes automatically disabling the wiper assembly 230 of a vehicle in response to detecting the factor. For purposes of this disclosure, “detecting a factor” caused by a washing operation of a car wash 220 can include detecting, measuring, monitoring, observing, recording, identifying, sensing, receiving, or otherwise perceiving any output, characteristic, feature, or attribute related to or indicative of the washing operation of a car wash. In one example, the factor can include a vibration. The vibration can be produced by contact of an element of the car wash with at least a portion of the vehicle. In another example, the factor can include a noise. The noise can be produced by contact of an element of the car wash with at least a portion of the vehicle. In still other examples, the factor can include an acceleration, a velocity, a movement, a displacement, a position, or any other factor produced by contact of an element of the car wash with at least a portion of the vehicle.

As further illustrated in FIG. 2, if the detected factor is caused by a washing operation of the car wash 235, the method can automatically disable the wiper assembly 230. Automatically disabling the wiper assembly can include maintaining the wiper assembly in a resting or immobile position. In another example, where the wiper assembly is operating to wipe the windshield, automatically disabling the wiper assembly can include stopping the operation of the wiper assembly and/or returning the wiper assembly to a resting or immobile position. In some examples, a manual override 250 may be provided to allow a user to manually override the automatic disabling of the wiper assembly 230. In other examples, automatically disabling the wiper assembly can override manual operation of the wiper assembly 205 and/or automatic operation of the wiper assembly 210.

As still further illustrated in FIG. 2, if the detected factor is not caused by a washing operation of a car wash 245, the method can enable the wiper assembly 240. Enabling the wiper assembly can include permitting the wiper assembly to function as normal. In one example, enabling the wiper assembly 240 may result in the wiper assembly remaining in a resting or immobile position. For example, if a user has not activated the wiper assembly, the wiper assembly may remain immobile. Additionally, if a rain sensor, light sensor, or other sensor has not detected precipitation, enabling the wiper assembly 240 may result in the wiper assembly remaining in a resting or immobile position. Alternatively, enabling the wiper assembly 240 may result in the commencement of or the continued or uninterrupted operation of the wiper assembly to wipe the windshield based on a manual operation by the user to activate the operation of the wiper assembly. Further, if a rain sensor, light sensor, or other sensor has detected precipitation, enabling the wiper assembly 240 may result in the commencement of or continued or uninterrupted operation of the wiper assembly to wipe the windshield.

As further shown in FIG. 1, the wiper assembly 100 can include a car wash detection apparatus 101 comprising a sensor 150 and a controller 170. The sensor 150 can be configured to send wired and/or wireless signals to the controller 170. Based at least on these signals, the controller 170 can be configured to control the operation of the motor 140, which, in turn, controls the operation of the wiper connecting member 130, the wiper arms 124, 125, and the wiper blades 120, 121. In one example, the sensor 150 can be configured to detect a factor caused by a washing operation of a car wash. In another example, the controller 170 can be configured to automatically disable the wiper assembly 100 of the vehicle 105 in response to receiving a signal from the sensor 150 indicating detection of the factor. The sensor 150 can include any sensor configured to detect, measure, monitor, observe, record, identify, sense, receive, or otherwise perceive any output, characteristic, feature, or attribute related to or indicative of the washing operation of a car wash.

In one example, the sensor 150 can be configured to detect a vibration. In another example, the sensor 150 can include an accelerometer or other device configured to detect the vibration, although other sensors may be used in other examples. The vibration can be produced by contact of an element of the car wash with at least a portion of the vehicle. The controller 170 can be configured to differentiate the vibration produced by contact from other vibrations. For example, the controller 170 can be configured to differentiate the vibration (e.g. side-to-side motion of the vehicle) produced by a scrubbing strand or brush contacting at least a portion of the vehicle from other vibrations. Other vibrations can include vibrations that occur when the vehicle is driven, such as a vibration produced by various road conditions, including bumps or holes in the road as well as engine vibrations. In addition, the controller 170 can be configured to differentiate the vibration produced by contact from engine idle vibrations, which in some examples, can be cyclic or of another recognizable pattern. Still further, other vibrations can include vibrations of the vehicle as a result of exposure to precipitation and/or high winds, the vibration of a speaker or subwoofer of the vehicle or other vehicles, the vibration of a nearby train, vibrations caused by construction equipment, including equipment for repairing a roadway as well as equipment used in relation to erection or demolition of a structure. For purposes of this disclosure, “other vibrations” includes any vibrations to which a vehicle may be subjected or which a vehicle may experience, that are not produced by contact of an element of the car wash with at least a portion of the vehicle, including vibrations resulting from the below described noises. Further, it is to be understood that vibrations produced by contact of an element of the car wash with at least a portion of the vehicle can include any vibrations related to or indicative of a washing operation of a car wash, including those vibrations not explicitly described herein.

In addition to or in the alternative to a vibration, in one example, the sensor 150 can be configured to detect a noise. In another example, the sensor 150 can include a microphone or other device configured to detect the noise, although other sensors may be used in other examples. The noise can be produced by contact of an element of the car wash with at least a portion of the vehicle. The controller 170 can be configured to differentiate the noise produced by contact from other vibrations. For example, the controller 170 can be configured to differentiate the noise (e.g. a characteristic thud or thump) produced by a scrubbing strand or brush contacting at least a portion of the vehicle from other noises. Other noises can include noises that occur when the vehicle is driven, such as a noise produced by various road conditions, including bumps or holes in the road. Other noises can also include noises of the vehicle as well as other vehicles, such as engine or muffler noise, noise produced by the wiper assembly 100, noise produced by a radio or stereo, and horn or siren noises. Still further, other noises can include noises produced by wind or precipitation, or other weather conditions, including noises produced during thunderstorms, the noise of a speaker or subwoofer of the vehicle or other vehicles, the noise of a nearby train, noise caused by construction equipment, including equipment for repairing a roadway as well as equipment used in relation to erection or demolition of a structure. For purposes of this disclosure, “other noises” includes any noises which may occur in or around a vehicle, that are not produced by contact of an element of the car wash with at least a portion of the vehicle, including noises resulting from the above described vibrations. Further, it is to be understood that noises produced by contact of an element of the car wash with at least a portion of the vehicle can include any noises related to or indicative of a washing operation of the car wash, including those noises not explicitly described herein.

While specific examples of sound and vibration sensors have been provided herein, it is to be understood that any sensor configured to detect a factor caused by a washing operation of a car wash can be used in accordance with the methods and apparatus of the disclosure. Accordingly, any sensor configured to detect a factor caused by a washing operation of a car wash is considered to be within the scope of the present application. Additionally, it is to be understood that the controller 170 can be configured to differentiate a factor caused by a washing operation of a car wash from other factors by, for example, comparing the detected factor to a threshold.

In other examples, the controller 170 can be configured to associate the detected factor with the threshold, match the detected factor with the threshold, or perform any other method or operation of or relating to the factor in order for the controller to determine whether the detected factor is caused by a washing operation of a car wash. The threshold can include one or more numeric values, one or more ranges of numeric values, a waveform, a pattern, an area under a curve, an integral, derivative, or other mathematical relationship, a predetermined or determinable constant, a predetermined or constant variable, as well as any other data for which a comparison with the detected factor produces information by which the controller 170 can determine whether the detected factor is caused by a washing operation of a car wash.

In some examples, if the detected factor is the same as or similar to the threshold (e.g. of the same or similar magnitude, amplitude, frequency, volume, decibels, acceleration, g′s, velocity, position, etc.), the controller 170 can be programmed (e.g. by using software to implement an algorithm) to determine that the factor is caused by a washing operation of a car wash. In other examples, if the detected factor is not equal to the threshold value (e.g. of a greater or lesser magnitude, amplitude, frequency, volume, decibels, acceleration, g′s, velocity, position, etc.), the controller 170 can be programmed to determine that the factor is caused by a washing operation of a car wash. Likewise, the controller 170 can be programmed to determine instances where the detected factor is not caused by a washing operation of a car wash. Such a determination can include instances where the detected factor is the same as or similar to a threshold as well as instances where the detected factor is different than the threshold.

Still further, at least one of the sensor 150 and the controller 170 can be configured to filter data and information to, for example, remove background interference that may adversely affect or disrupt the sensing capabilities of the sensor 150 or the computing ability of the controller 170 as well as outlier data that may fall outside a predicted or anticipated range of detection. In other examples, at least one of the sensor 150 and the controller 170 can be operated based on a timing sequence. The timing sequence can be predetermined to, for example, delay a sensing operation of the sensor 150, require a particular factor to be sensed continuously during a predetermined duration of time, or to require the factor to occur a predetermined number of times prior to the controller 170 activating or deactivating operation of the wiper assembly 100.

A vehicle 105 can include the car wash detection apparatus 101. For example, the vehicle 105 can include the sensor 150 configured to detect a factor caused by a washing operation of a car wash. The vehicle 105 can also include the controller 170 configured to automatically disable a wiper assembly 100 of the vehicle 105 in response to receiving a signal from the sensor 150 indicating detection of the factor. In one example, the vehicle 105 can include another sensor 160, as shown in FIG. 1. The other sensor 160 can be configured to detect precipitation in the form of a rain sensor, light sensor, or other sensor. The controller 170 can be further configured to automatically operate the wiper assembly 100 in response to receiving a signal from the other sensor 160 indicating detection of precipitation. Although illustrated as a separate controller 170, it is to be understood that the controller could be integral to the sensor 150 or the other sensor 160 as well as integral to the motor 140 or any other component of the vehicle. Additionally, the controller 170 can include any one or more of a microcontroller, programmable logic controller (PLC), discrete controller, circuit, or other controller.

In another example, the controller 170 can be configured to override the automatic operation of the wiper assembly 100 to automatically disable the wiper assembly, in response to receiving the signal from the sensor 150 indicating detection of the factor. In still another example, the wiper assembly 100 can be operated manually (e.g. by a driver of the vehicle selecting a rate at which to operate the wiper assembly to wipe the windshield). In response to detection of the factor, the automatic disabling of the wiper assembly 100 can override the manual operation of the wiper assembly and automatically disable the wiper assembly 100. In another example, the automatic disabling of the wiper assembly 100 can be manually overridden (e.g. by a driver of the vehicle selecting a rate at which to operate the wiper assembly to wipe the windshield).

In yet another example, the controller 170 can be configured to automatically disable the wiper assembly 100 in response to receiving the signal from the sensor 150 indicating detection of the factor in combination with a signal indicating at least one of a state of a transmission of the vehicle, a speed of the vehicle, and a state of a brake pedal of the vehicle. The state of the transmission of the vehicle can include at least one of neutral, park, or drive the state of which can be monitored by the controller 170. In one example, the controller 170 can be configured to automatically disable the wiper assembly 100 in response to receiving the signal from the sensor 150 indicating detection of the factor and in response to receiving a signal indicating the state of the transmission as one of neutral or park. The state of the brake pedal can be applied or not applied. In another example, the controller 170 can be configured to automatically disable the wiper assembly 100 in response to receiving the signal from the sensor 150 indicating detection of the factor and in response to receiving a signal indicating the state of the transmission as drive, where the state of the brake pedal of the vehicle is applied. Such a scenario may indicate that the driver has driven the vehicle into a car wash and, without changing the state of the transmission from drive, has applied the brake pedal to keep the vehicle from moving during the washing operation. In still another example, the controller 170 can be configured to automatically disable the wiper assembly 100 in response to receiving the signal from the sensor 150 indicating detection of the factor and in response to receiving a signal indicating a particular speed or range of speeds of the vehicle. The particular speed or range of speeds of the vehicle can include no speed (e.g. zero), a low speed (e.g. 0-5 mph), or any speed at which a vehicle may pass through a car wash.

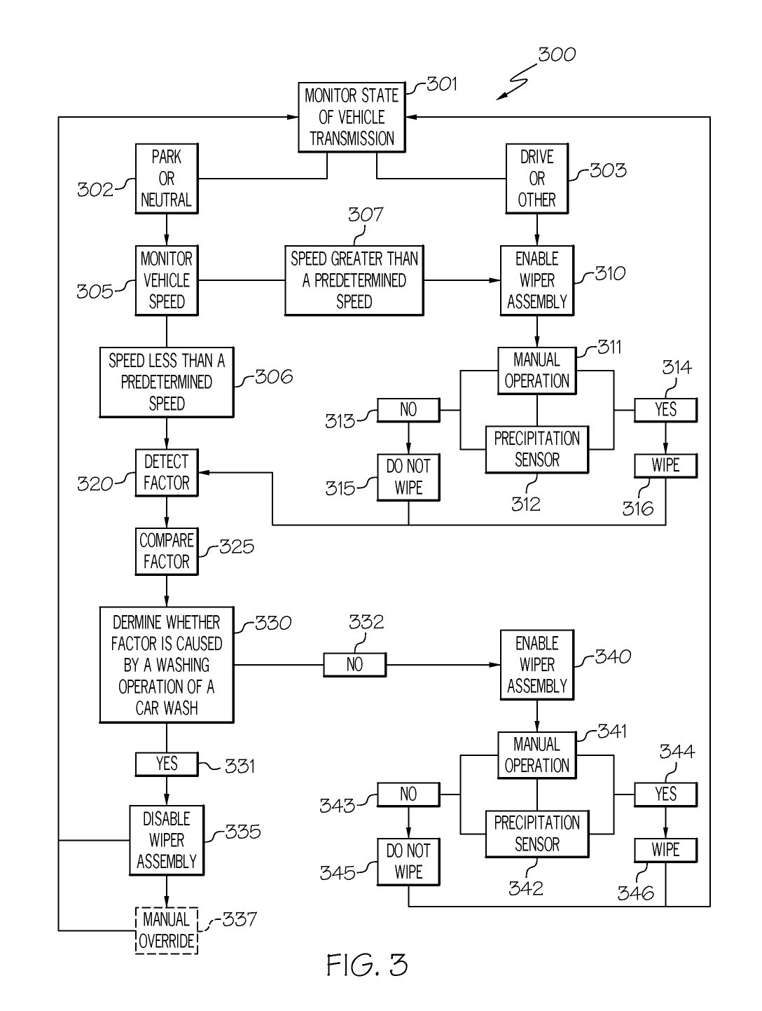

Another example car wash detection method 300 is schematically illustrated in FIG. 3 and can include, alone or in combination, one or more features of the example car wash method 200 illustrated in FIG. 2 and described above, one or more features of the example wiper assembly 100 illustrated in FIG. 1 and described above as well as one or more additional features including those illustrated in FIG. 3 and described herein as well as other features including those not explicitly described herein. The example car wash detection method 300 can monitor a state of the vehicle transmission 301, wherein if the state of the transmission is park or neutral 302, the method then monitors a speed of the vehicle 305. If the speed of the vehicle is greater than a predetermined speed 307, the method can enable the wiper assembly 310. If the speed of the vehicle is less than a predetermined speed 306, the method can then detect a factor 320. Alternatively, if the state of the vehicle transmission is drive or another state 303, the method can enable the wiper assembly 310. Enabling the wiper assembly 310 can include manual operation 311 of the wiper assembly and/or operation based on a precipitation (e.g. rain) sensor 312. If either or both the manual operation 311 or precipitation sensor 312 indicate affirmative operation 314 (e.g. manual operation of the wiper assembly is activated or rain is detected by the rain sensor), the method can cause the wiper assembly to operate to wipe 316 a surface. On the other hand, if either or both the manual operation 311 or precipitation sensor 312 indicate negative operation 313 (e.g. manual operation of the wiper assembly is not activated or no rain is detected by the rain sensor), the method can prevent the wiper assembly from operating such that the wiper assembly does not wipe 315 the surface. Following either the command to wipe 316 or the command not to wipe 315, the method can then detect a factor 320.

After detecting the factor 320, the method can compare the factor 325 and then determine whether the factor is caused by a washing operation of a car wash 330. If the factor is caused by a washing operation of a car wash 331, the method can disable the wiper assembly 335. Optionally, the method can include a manual override 337 of the step that disables the wiper assembly 335. Following these steps, the method can be repeated to again monitor a state of the vehicle transmission 301. If the factor is not caused by a washing operation of a car wash 332, the method can enable the wiper assembly 340. As discussed above, enabling the wiper assembly 340 can include manual operation 341 of the wiper assembly and/or operation based on a precipitation (e.g. rain) sensor 342. If either or both the manual operation 341 or precipitation sensor 342 indicate affirmative operation 344 (e.g. manual operation of the wiper assembly is activated or rain is detected by the rain sensor), the method can cause the wiper assembly to operate to wipe 346 a surface. On the other hand, if either or both the manual operation 341 or precipitation sensor 342 indicate negative operation 343 (e.g. manual operation of the wiper assembly is not activated or no rain is detected by the rain sensor), the method can prevent the wiper assembly from operating such that the wiper assembly does not wipe 345 the surface. Following either the command to wipe 346 or the command not to wipe 345, the method can be repeated to again monitor a state of the vehicle transmission 301.

It is to be understood that the example car wash method 300 can be performed a single time, more than one time, or continuously in a loop, for example. Additionally, it is to be understood that manual or automatic operation of the wiper assembly 205, 210 (FIG. 2) can include the same, similar, or different features corresponding to manual operation 311, 341 and precipitation sensor 312, 342 (FIG. 3). In addition, detecting a factor 220 (FIG. 2) can include the same, similar, or different features corresponding to detecting a factor 320 (FIG. 3). Similarly, comparing the factor 222 and determining whether the factor is caused by a washing operation of a car wash 225 (FIG. 2) can include the same, similar, or different features corresponding to comparing the factor 325 and determining whether the factor is caused by a washing operation of a car wash 330 (FIG. 3). Likewise, disabling the wiper assembly 230 including manual override 250 as well as enabling the wiper assembly 240 (FIG. 2) can include the same, similar, or different features corresponding to disabling the wiper assembly 335 including manual override 337 and enabling the wiper assembly 310, 340 (FIG. 3).

Many other example embodiments can be provided through various combinations of the above described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

What is claimed is:

1. A car wash detection method comprising:
detecting a factor caused by a washing operation of a car wash, and automatically disabling a wiper assembly of a vehicle in response to detecting the factor.

2. The method of claim 1, wherein the factor comprises a vibration.

3. The method of claim 2, wherein the vibration is produced by contact of an element of the car wash with at least a portion of the vehicle.

4. The method of claim 1, wherein the factor comprises a noise.

5. The method of claim 4, wherein the noise is produced by contact of an element of the car wash with at least a portion of the vehicle.

6. The method of claim 1, further comprising:
automatically operating the wiper assembly upon detection of precipitation; wherein automatically disabling the wiper assembly in response to detecting the factor overrides the automatic operation of the wiper assembly and automatically disables the wiper assembly.

7. The method of claim 1, further comprising:
manually operating the wiper assembly; wherein, automatically disabling the wiper assembly in response to detecting the factor overrides the manual operation of the wiper assembly and automatically disables the wiper assembly.

8. The method of claim 1, wherein automatically disabling the wiper assembly is dependent on at least one of a state of a transmission of the vehicle, a speed of the vehicle, and a state of a brake pedal of the vehicle.

9. The method of claim 1, further comprising manually overriding the automatic disabling of the wiper assembly.

10. A car wash detection apparatus comprising:
a sensor configured to detect a factor caused by a washing operation of a car wash; and
a controller configured to automatically disable a wiper assembly of a vehicle in response to receiving a signal from the sensor indicating detection of the factor.

11. The car wash detection apparatus of claim 10, wherein the sensor is configured to detect a vibration.

12. The car wash detection apparatus of claim 11, wherein the vibration is produced by contact of an element of the car wash with at least a portion of the vehicle.

13. The car wash detection apparatus of claim 12, wherein the controller is configured to differentiate the vibration produced by contact from other vibrations.

14. The car wash detection apparatus of claim 10, wherein the sensor is configured to detect a noise.

15. The car wash detection apparatus of claim 14, wherein the noise is produced by contact of an element of the car wash with at least a portion of the vehicle.

16. The car wash detection apparatus of claim 15, wherein the controller is configured to differentiate the noise produced by contact from other noises.

17. The car wash detection apparatus of claim 10, wherein the sensor comprises at least one of an accelerometer and a microphone.

18. A vehicle comprising a car wash detection apparatus, comprising:
a sensor configured to detect a factor caused by a washing operation of a car wash; and
a controller configured to automatically disable a wiper assembly of the vehicle in response to receiving a signal from the sensor indicating detection of the factor.

19. The vehicle of claim 18, further comprising:
another sensor configured to detect precipitation, wherein
the controller is further configured to automatically operate the wiper assembly in response to receiving a signal from the other sensor indicating detection of precipitation, and
wherein the controller is configured to override the automatic operation of the wiper assembly to automatically disable the wiper assembly in response to receiving the signal from the sensor indicating detection of the factor.

20. The vehicle of claim 18, wherein the controller is configured to automatically disable the wiper assembly in response to receiving the signal from the sensor indicating detection of the factor in combination with a signal indicating at least one of a state of a transmission of the vehicle, a speed of the vehicle, and a state of a brake pedal of the vehicle.
